(19) United States
(12) Patent Application Publication
(10) Pub. No.: US 2015/0338046 A1
(43) Pub. Date: Nov. 26, 2015

(54) VEHICLE LAMP

(71) Applicant: SL Corporation, Daegu (KR)

(72) Inventors: Sun Kyoung Park, Gyeongsan (KR); Jin Young Jung, Gyeongsan (KR); Gi Man Park, Gyeongsan (KR)

(73) Assignee: SL Corporation

(21) Appl. No.: 14/715,851

(22) Filed: May 19, 2015

(30) Foreign Application Priority Data
May 23, 2014 (KR) 10-2014-0062248

(51) Int. Cl. F21S 8/10

(52) U.S. Cl. CPC F21S 48/1317; F21S 48/328; F21S 48/321; F21S 48/1225

(57) ABSTRACT

A vehicle lamp is provided that includes a light source and a reflector that is configured to reflect light from the light source toward a front of a vehicle. In addition, the lamp includes a heat sink which that has a rear part that is disposed behind the reflector, a lateral part that extends from the rear part toward the front of the vehicle, and a front part that extends from the lateral part to partially overlap the rear part. The light source is disposed on an inner surface of the front part or the lateral part of the heat sink.

### CROSS-REFERENCE TO RELATED APPLICATION(S)

This application claims priority from Korean Patent Application No. 10-2014-0062248 filed on May 23, 2014 in the Korean Intellectual Property Office, the disclosure of which is incorporated herein by reference in its entirety.

### BACKGROUND

1. Field of the Invention

The present invention relates to a vehicle lamp, and more particularly, to a vehicle lamp which outputs a particular image by exposing a heat sink.

2. Description of the Related Art

Generally, a vehicle is equipped with various vehicle lamps having a lighting function and a signaling function. In particular, the vehicle lamps enable the driver to detect objects around the vehicle while driving at night (e.g., with low exterior light) and notify other vehicles and road users of the vehicle's driving state. For example, the vehicle lamps may include lamps that directly emit light, such as a headlamp that illuminates the road ahead to secure the driver's field of view, a brake light turned on when a brake pedal is engaged, and a direction indicator used to indicate a right or left turn intention. In addition, a reflector may be installed on the front and rear sides of the vehicle to reflect light such that the vehicle is more easily recognizable.

These vehicle lamps generally use a halogen lamp or a high-intensity discharge (HID) lamp as a light source. A typical example of the light source is a light-emitting diode (LED). The LED has a color temperature of approximately 5500 K which is close to sunlight. Thus, the LED causes the least eye fatigue. In addition, the LED increases the freedom of lamp design due to being of a substantially small size and is economical due to a semi-permanent life. Recently, a lamp module has been designed to perform other functions in addition to the lighting function and the signaling function. Particularly, the lamp module now improves visibility and awareness about a particular product by emitting a particular form of light. However, since changing the form of emitted light is a technology that has been available, a product is not easily distinguishable from other products using this technology.

### SUMMARY

Aspects of the present invention provide a vehicle lamp which outputs a particular image that may distinguish a product from other products by exposing a heat sink. However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, a vehicle lamp may include: a light source; a reflector configured to reflect light from the light source toward a front of a vehicle; and a heat sink which includes a rear part disposed behind the reflector, a lateral part that extends from the rear part toward the front of the vehicle, and a front part that extends from the lateral part to partially overlap the rear part, wherein the light source is disposed on an inner surface of the front part or the lateral part of the heat sink.

### BRIEF DESCRIPTION OF THE DRAWINGS

The above and other aspects and features of the present invention will become more apparent by describing in detail exemplary embodiments thereof with reference to the attached drawings, in which:

FIG. 1 is an exemplary perspective view of a vehicle lamp according to an exemplary embodiment of the present invention;

FIG. 2 is an exemplary cross-sectional view taken along the line A-A of FIG. 1 according to an exemplary embodiment of the present invention; and

FIGS. 3 through 8 are exemplary enlarged views of a portion ‘B’ of FIG. 1 according to exemplary embodiments of the present invention.

### DETAILED DESCRIPTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps and/or operations but do not preclude the presence or addition of one or more other components, steps and/or operations. As used herein, the term “and/or” includes any and all combinations of one or more of the associated listed items.

Hereinafter, the present invention will be described with reference to the attached drawings.

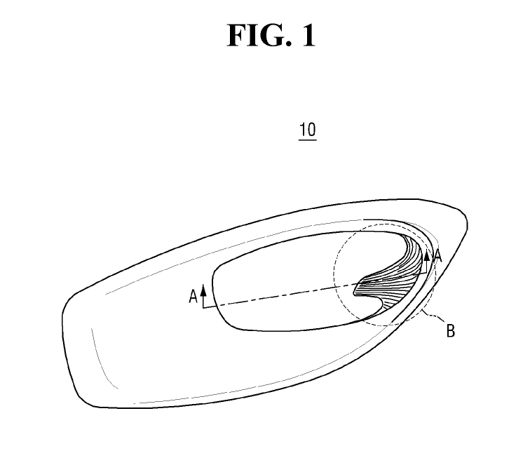

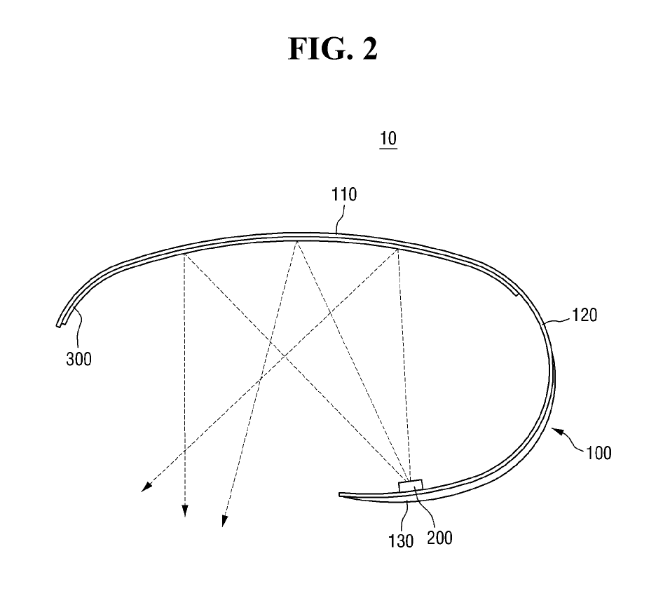

FIG. 1 is an exemplary perspective view of a vehicle lamp 10 according to an exemplary embodiment of the present invention. FIG. 2 is an exemplary cross-sectional view taken along the line A-A of FIG. 1. Referring to FIGS. 1 and 2, the vehicle lamp 10 according to the present invention may include a heat sink 100, a light source 200, and a reflector 300. However, the present invention does not preclude the addition of other components.

In the present invention, the vehicle lamp 10 may be, but is not limited to, a headlamp. In addition, in the present invention, the vehicle lamp 10 may be a lamp that may be disposed on a left or right side of a vehicle. Therefore, it can be understood that a vehicle lamp (not described herein) disposed on the other side of the vehicle has the same configuration as the vehicle lamp 10 of the present invention (e.g., left and right lamps may have the same configuration) or is horizontally symmetrical to the vehicle lamp 10 of the present invention.

The heat sink 100 may include a rear part 110, a lateral part 120, and a front part 130. In particular, the heat sink 100 may be configured to suppress an increase in the temperature of the vehicle lamp 10 by dissipating heat generated by the light source 200. In the exemplary embodiment of the present invention, a light-emitting diode (LED) may be used as the light source 200 as will be described later. However, since the LED is vulnerable to high heat, the performance of the LED may be undermined such high heat. Therefore, the heat sink 100 may be used to prevent a temperature rise due to heat generated from the LED. The rear part 110 may form a space in which the reflector 200 may be disposed and may be shaped after the reflector 200 to have a substantially parabolic shape. However, the shape, size, etc. of the rear part 110 are not limited to a particular shape, size, etc. as long as the reflector 200 may be disposed on the rear part 110.

The lateral part 120 may extend toward the front of the vehicle from one of both sides of the rear part 110. In the exemplary embodiment of the present invention, the right vehicle lamp 10 is described as an example. Therefore, the lateral part 120 may extend toward the front of the vehicle from a side of the rear part 110 disposed in an outward direction of the vehicle. However, the present invention is not limited thereto, and the lateral part 120 may also extend toward the front of the vehicle from a side of the rear part 110 located in an inward direction of the vehicle.

The front part 130 may extend from a side of the lateral part 130 to partially overlap the rear part 110. The front part 120 and the lateral part 120 may form a space in which the light source 200 may be disposed. In other words, the area of the front part 130 may be of a smaller size than that of the rear part 110. Therefore, when the vehicle lamp 10 is viewed from the front of the vehicle, the front part 130 partially hides the rear part 110. The detailed shape and configuration of the front part 130 will be described later.

Therefore, when viewed from above, the heat sink 100 including the rear part 110, the lateral part 120 and the front part 130 may be, shaped as a curved surface. Particularly, the heat sink 100 may have, a substantially ‘J’ shape. In FIGS. 1 and 2, all of the rear part 110, the lateral part 120, the front part 130, and connection regions thereof may be curved. However, some of these parts may also be substantially straight or may consist of a combination of a substantially straight line and a curve.

The light source 200 may be disposed on an inner surface of the front part 130 or the lateral part 120 of the heat sink 100 to emit light toward the side or the rear of the vehicle. An LED, a bulb, etc. may be used as the light source 200. In particular, the LED is a semiconductor device configured to convert an electric current directly into light using a phenomenon that a forward voltage applied using a p-n junction of a semiconductor causes electrons in an n region to recombine with electron holes in a p region, thus emitting light. Generally, a white LED having a single light-emitting chip of approximately 1 mm square may be used. However, it will be obvious to those of ordinary skill in the art that the LED is not limited to the white LED. The light source 200 may also be a multi-chip LED package. In this case, a more abundant amount of light may be obtained than when the white LED having a single light-emitting chip is used.

The reflector 300 may be disposed on an inner surface of the rear part 110 of the heat sink 100 to reflect light from the light source 200 toward the front of the vehicle. Particularly, the reflector 300 may form a parabolic optical system with one open surface to reflect light from the light source 200 toward the front of the vehicle, and the light source 200 may be disposed at the focus of the reflector 300. The reflector 300 may be shaped as a free curved surface to reflect light from the light source 200 toward the front of the vehicle while being disposed on a side of or behind the light source 200. In addition, the light source 200 may be tilted at a predetermined angle toward the upper, lower, left and/or right side of the vehicle to reduce the amount of light leaked and to improve the efficiency of light reflected by the reflector 300 toward the front of the vehicle. The predetermined angle is not limited to a particular angle and is an angle at which the efficiency of light may be increased.

In the exemplary embodiment of the present invention, when the reflector 300 is disposed on a side of or behind the light source 200, the whole the reflector 300 and parts of the reflector 300 may be disposed on the side of or behind the light source 200. Since the front part 130 of the heat sink 100 may operate as a shade, light emitted from the light source 200 may prevented from being projected directly to the front of the vehicle. Therefore, glare may be prevented, and uniform light may be obtained using light reflected by the reflector 300. In addition, when light emitted from the vehicle lamp 10 according to the exemplary embodiment forms a low beam distribution pattern, the front part 130 may form a cut-off line for preventing dazzling other drivers in the low beam distribution pattern (e.g., light causing other drivers to have difficulty with visibility).

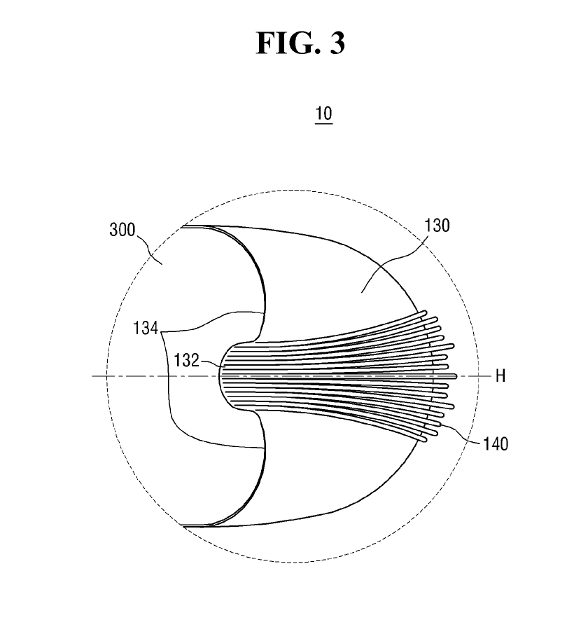

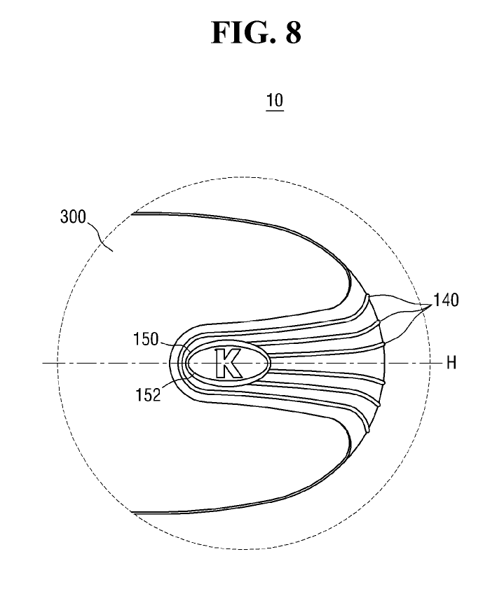

Hereinafter, exemplary embodiments of the vehicle lamp 10 according to various shapes and configurations of the front part 130 of the heat sink 100 will be described. FIGS. 3 through 8 are exemplary enlarged views of a portion ‘B’ of FIG. 1 according to exemplary embodiments of the present invention.

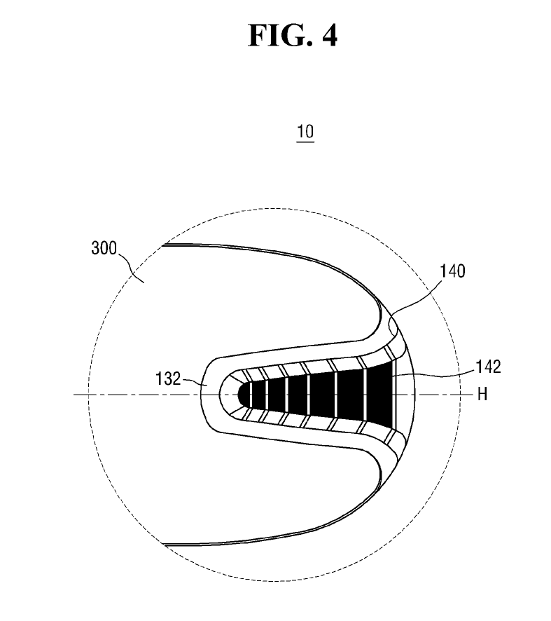

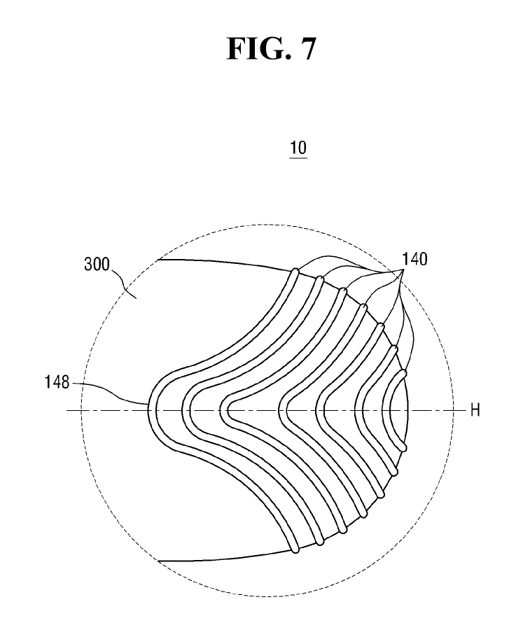

Referring to FIGS. 3 through 8, the front part 130 exposed on the front of the vehicle lamp 10 may include a protruding region 132 and a curved region 134 which may be curved from the protruding region 132 toward upper and lower ends of the lateral part 120 or upper and lower ends of the rear part 110. For example, the curved region 134 may be curved toward the upper and lower ends of the lateral part 120 as shown in FIGS. 4 through 6 or may be curved toward the upper and lower ends of the rear part 110 as shown in FIGS. 3 and 7.

In addition, the curved region 134 may be curved toward the lateral part 120 in a concave shape as shown in the drawings. However, the curved region 134 may also be curved in a convex shape. In particular, the curved region 134 may be vertically symmetrical with respect to a horizontal line H. In the present invention, the term “vertically symmetrical” may denote vertically symmetrical not only mathematically but also as viewed by the naked eye. In addition, an outer surface of the front part 130 may include a plurality of heat dissipation pins 140 to form a predetermined pattern. The heat dissipation pins 140 may increase awareness regarding a particular manufacturer using the predetermined pattern and improve the effect of dissipating heat from the light source 200 by increasing the area of heat dissipation. In other words, the heat dissipation pins 140 may allow a particular symbol that indicates a particular manufacturer to be illuminated.

The heat dissipation pins 140 may be stacked at different angles to the horizontal line H. For example, referring to FIG. 1, the heat dissipation pins 140 may extend from the protruding region 132 toward the lateral part 120 at different angles. The different angles may be angles perceived by those of ordinary skill in the art to be different with respect to the horizontal line H when the heat dissipation pins 140 are curved and when the heat dissipation pins 140 are substantially straight. In addition, the heat dissipation pins 140 may be stacked in a central region of the front part 130 at a predetermined angle to the horizontal line H. For example, referring to FIG. 3, the heat dissipation pins 140 may extend from the protrusion region 132 in the central region of the front part 130 toward a central region of the lateral part 120 at a predetermined angle.

The heat dissipation pins 140 may extend from the central region of the front part 130 toward the lateral part 120 or upper and lower surfaces of the rear part 110 at a predetermined angle. The predetermined angle is not limited to any particular angle. In particular, all of the heat dissipation pins 140 may be formed at equal angles to the horizontal line H. Alternatively, some of the heat dissipation pins 140 may be at equal angles to the horizontal line H, and the other ones may be at different angles to the horizontal line H. The equal angles may be angles perceived by those of ordinary skill in the art to be about equal.

The heat dissipation pins 140 may also have different step heights (e.g., the pins may be formed at different vertical heights). Particular, some of the heat dissipation pins 140 may have a first height, some other ones may have a second height, and the remaining ones may have a third height. In other words, a first group of pins may have a first height, a second group of pins may have a second height, and a third group of pins may have a third height. For example, referring to FIG. 3, of the fifteen heat dissipation pins shown, a first heat dissipation pin at the top and a fifteenth heat dissipation pin at the bottom may have the first height which is a lowest height (e.g., a minimum height), whereas the fifth, eighth and eleventh heat dissipation pins may have the third height which is a highest height (e.g., a maximum height).

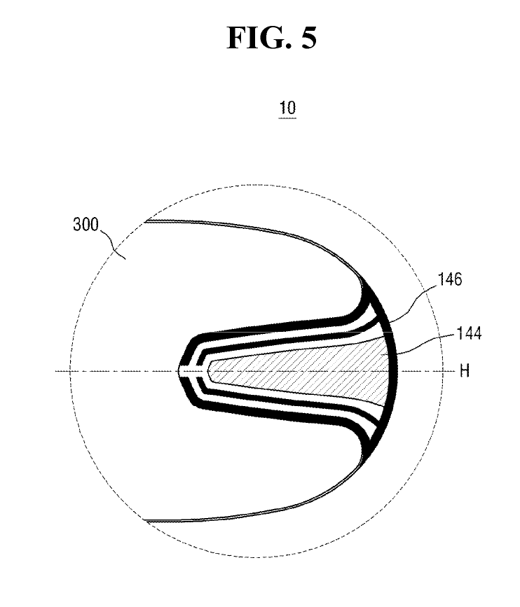

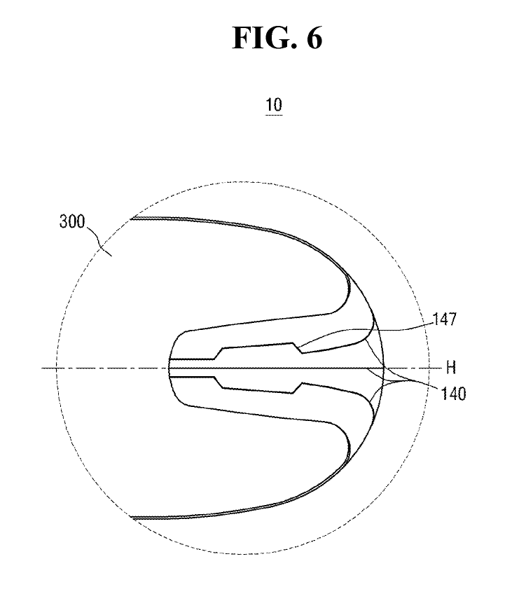

In addition, referring to FIGS. 4 and 5, the heat dissipation pins 140 according to an exemplary embodiment of the present invention may include heat dissipation pins 140, 142, 144 and 146 having different widths. Some of the heat dissipation pins 140 may be heat dissipation pins (e.g., a heat dissipation pin 146) having a predetermined shape (e.g., a substantially triangular shape). Particularly, some of the heat dissipation pins 140 (e.g., a first group of pins) may have a first width, and the other ones (e.g., a second group of pins) may have a second width. In addition, at least some of the heat dissipation pins 140 may be bent (e.g., not substantially straight). For example, referring to FIG. 6, at least some 147 of the heat dissipation pins 140 may be bent, and one heat dissipation pin may be bent a number of times as shown in the drawing (e.g., may include multiple curves). In particular, the term “bent” encompasses all cases where a heat dissipation pin may be perceived by those of ordinary skill in the art to be bent.

Further, the heat dissipation pins 140 may be curved toward a predetermined region. For example, referring to FIG. 7, the heat dissipation pins 140 may be curved toward a region 148 of the protruding region 132 of the front part 130. Unlike in the drawing, the heat dissipation pins 140 may be curved toward a region other than the protruding region 132. Alternatively, only some of the heat dissipation pins 140 may be curved, and the heat dissipation pins 140 may be curved in a convex shape and in a concave shape.

Additionally, the heat dissipation pins 140 may be vertically symmetrical with respect to the horizontal line H. For example, referring to FIGS. 1 and 3 through 8, the heat dissipation pins 140 may be vertically symmetrical with respect to the horizontal line H. The term “vertically symmetrical” encompasses all cases where the heat dissipation pins 140 are perceived by those of ordinary skill in the art to be vertically symmetrical as well as a case where the pins are vertically symmetrical mathematically.

The outer surface of the front part 130 may include an emblem region 150 in which an emblem 152 is disposed. In particular, the emblem region 150 may be formed of a transparent or semi-transparent material. Therefore, the emblem region 150, together with the heat dissipation pins 140, may increase awareness or visibility of a particular manufacturer's product. In other words, the emblem region 150 may indicate a particular manufacturer to a user. In addition, the emblem region 150 formed of a transparent or semi-transparent material may have an outer circumferential surface 152 which is a glitter material (e.g., a shiny material). In FIG. 7, the emblem 152 shows the letter ‘K’ and an oval shape. However, the emblem 152 may be formed as various characters and shapes that may be employed in the art to which the present invention pertains. The emblem region 150 may be any region (such as an aperture or a recess) that may be employed by those of ordinary skill in the art as long as the emblem 152 may be disposed therein.

Moreover, features of the heat dissipation pins 140 and the front part 130 described above in the exemplary embodiments of the present invention may be used alone or in combination to form a predetermined pattern that may improve visibility of a particular manufacturer. Therefore, according to exemplary embodiments of the present invention, it may be possible to prevent glare and obtain a uniform intensity of illumination using a heat sink exposed on the front. In addition, a particular image or shape that distinguishes a vehicle from other vehicles may be expressed through the predetermined pattern.

Exemplary embodiments of the present invention provide at least one of the following advantages. According to the present invention, it may be possible to express a particular image or shape that may distinguish a vehicle from other vehicles (e.g., based on vehicle manufacturer) by exposing a heat sink. However, the effects of the present invention are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A vehicle lamp, comprising:
a light source;
a reflector configured to reflect light from the light source toward a front of a vehicle; and
a heat sink including a rear part disposed behind the reflector, a lateral part that extends from the rear part toward the front of the vehicle, and a front part that extends from the lateral part to partially overlap the rear part,
wherein the light source is disposed on an inner surface of the front part or the lateral part of the heat sink.

2. The vehicle lamp of claim 1, wherein the heat sink forms a curved surface.

3. The vehicle lamp of claim 1, wherein the front part includes a protruding region and a curved region which is curved from the protruding region toward upper and lower ends of the lateral part or upper and lower ends of the rear part.

4. The vehicle lamp of claim 3, wherein the curved region is vertically symmetrical with respect to a horizontal line.

5. The vehicle lamp of claim 1, wherein an outer surface of the front part includes a plurality of heat dissipation pins that form a predetermined pattern.

6. The vehicle lamp of claim 5, wherein the heat dissipation pins are stacked at different angles to the horizontal line.

7. The vehicle lamp of claim 5, wherein the heat dissipation pins are vertically symmetrical with respect to the horizontal line.

8. The vehicle lamp of claim 5, wherein the heat dissipation pins are stacked in a central region of the front part at a predetermined angle to the horizontal line.

9. The vehicle lamp of claim 5, wherein the heat dissipation pins have different step heights.

10. The vehicle lamp of claim 5, wherein at least some of the heat dissipation pins are bent.

11. The vehicle lamp of claim 5, wherein the heat dissipation pins are curved toward a predetermined region.

12. The vehicle lamp of claim 1, wherein the outer surface of the front part includes an emblem region in which an emblem is disposed.

13. The vehicle lamp of claim 12, wherein the emblem region is formed of a transparent or semi-transparent material.

14. The vehicle lamp of claim 11, wherein the reflector forms a parabolic optical system configured to reflect incident light toward the front of the vehicle.

15. The vehicle lamp of claim 1, wherein an area of the front part is smaller in size than that of the rear part.
